(19) United States
(12) Patent Application Publication
(10) Pub. No.: US 2021/0395957 A1
(43) Pub. Date: Dec. 23, 2021

(54) COURT TILE FOR AN ATHLETIC EVENT AND METHOD OF MARKING AND INSTALLING THE SAME

(71) Applicants: William Womack Milton, Searcy, AR (US); Philip Andrew Walker, Searcy, AR (US)

(72) Inventors: William Womack Milton, Searcy, AR (US); Philip Andrew Walker, Searcy, AR (US)

(21) Appl. No.: 16/946,437

(22) Filed: Jun. 22, 2020

(51) Int. Cl. E01C 13/04; E04F 15/22; E04F 15/02

(52) U.S. Cl. CPC E01C 13/04; E04F 15/02194; E04F 15/22

(57) ABSTRACT

A court tile for an athletic event and method of marking and installing the same. A court tile includes a plurality of playing surface boards, a plurality of first sub floor members are disposed between surface boards and a second sub floor layer. Resilient pads are provided for cushioning of the court tile. A sliding pad covers the resilient pads to permit positioning of the court tile on the venue floor. A system and method of marking a court pre-printing a segment of the court markings on a court tile. A method of creating a court with markings includes pre-marking each of a plurality of court tiles with a selected segment of a court marking for which the court tile is intended and assembling a court surface according to a predetermined placement of the pre-marked court tiles.

### BACKGROUND OF THE INVENTION

The present invention relates to flooring systems, and more particularly to marking systems flooring systems, such as athletic courts.

Currently, to apply markings to an athletic court, such as basketball courts, the flooring surface must be laid out completely at the installation site. Court markings, including markings for the play area, arena or facility, a name, team logos, and the like are applied to the laid-out surface. This equates to a dusty environment at the installation site, plus fumes, VOCs, and long lead-times (2-3 weeks).

The current process of a contractor's going to the site of the basketball court in order to install or refinish it is time consuming, labor intensive, and environmentally unsafe. The current process requires a contractor to travel to the location of the basketball court and spend several days or weeks at the location either installing the court or refinishing it. Additionally, the current process requires at least six laborers in order to complete the project. Finally, the use of sanding machines and potentially harmful chemicals during the process exposes third parties to unknown risks, including dust particles and VOC exposure.

As can be seen, there is a need for an improved system, method, and apparatus for installing a marked floor in an athletic court

### SUMMARY OF THE INVENTION

In one aspect of the present invention, a court tile for assembly into an athletic court surface, is disclosed. The court tiles include a plurality of floor surface boards interconnected in a close-fitting relation and dimensioned, when joined, as a rectangular tile. A first sub floor is formed of a plurality of sub floor members disposed in a spaced apart relation along a longitudinal length of the floor surface boards. The plurality of sub floor members are attached in parallel across a transverse width of the plurality of floor surface boards. A second sub floor layer is attached to the first sub floor. The second sub floor layer formed as a rectangular board having a longitudinal and a transverse dimension corresponding to the rectangular tile of the joined plurality of floor surface boards. A plurality of resilient pads are disposed in a spaced apart relation around a bottom peripheral edge of the second sub floor layer. A slide pad covers the plurality of resilient pads and is formed of a polymeric material that permits the court tile to be slid on a supporting ground surface.

In some embodiments, the plurality of floor surface boards are interconnected in a tongue and a groove fitting.

In some embodiments, a moisture barrier is disposed subjacent to the second sub floor layer.

In some embodiments, a terminal end of each of the plurality of first sub floor members is offset from a longitudinal edge of the floor surface board to define a gap between a bottom of the plurality of floor surface boards and the second sub floor layer.

In some embodiments, a first sub floor member protrudes from a first transverse edge of the court tile to define a tongue element for the court tile. The first sub floor member is inset from an opposite transverse edge of the court tile to define a groove element for the court tile.

In other embodiments, an L-shaped joint element has a thickness dimensioned to fit the gap. A first leg is dimensioned to extend to the terminal end of the first sub floor member and protrude from an outer edge of the floor tile. A second leg is dimensioned to protrude from a transverse edge of the floor tile. The L-shaped joint element is adapted to be fit to a corner of the court tile and join a corner or an edge of an adjacent court tile placed in abutment with the court tile.

In other aspects of the invention, a system for pre-marking a court tile with a court marking of an athletic court surface formed by a plurality of the court tiles is disclosed. The system includes a first spray booth configured to apply a seal coat to a floor surface board of a court tile. A printer is configured to apply a selected portion of an image corresponding to a layout of the athletic court. A second spray booth is configured to apply a finishing coat to the floor surface board. A conveyor is configured to carry the court tile through the system.

In some embodiment, the printer is configured to apply an ultraviolet curable marking material and the printer further includes an ultraviolet curing to the selected portion of the image.

In other embodiments, a cleaning station disposed before the first finishing station. The cleaning station configured to remove surface impurities from at least a top surface of the floor surface boards.

In some embodiments, a preheater is disposed preceding the first spray booth. A preheater may also be disposed preceding the second spray booth.

In some embodiments, a curing oven is disposed subsequent to the second spray booth. The curing oven is configured to cure the finishing layer on the court tile.

In some embodiments, a cooling zone is disposed subsequent to the curing oven, configured to cool the court tile.

In other aspects of the invention, a method of forming an athletic court having a playing surface carrying a plurality of markings for an athletic event played on the athletic court is disclosed. The method includes joining a plurality of interconnected floor surface boards to form a court tile that is interconnectable with a plurality of court tiles to define the playing surface of the athletic court. Each of the plurality of court tiles is marked with a selected segment of the marked surface before the plurality of court tiles are assembled as the athletic court. Each of the plurality of court tiles is placed according to an intended placement in the athletic court.

In some embodiments, each of the plurality of court tiles is indexed according to the intended placement in the athletic court.

Once placed, each of the plurality of court tiles is joined in a venue according to the intended placement. Once joined, the plurality of court tiles present the plurality of markings according to a specified disposition for the playing surface of the athletic court.

These and other features, aspects and advantages of the present invention will become better understood with reference to the following drawings, description and claims.

### BRIEF DESCRIPTION OF THE DRAWINGS

FIG. 1 is an exploded view of a court tile;

FIG. 2 is a perspective view of the tile with end pieces exploded;

FIG. 3 is a view of the tiles being assembled;

FIG. 4A is the construction process of the tile part 1;

FIG. 4B is the construction process of the tile part 2;

FIG. 5 is a view of the board being fed to a sander; and

FIG. 6 is a top plan view showing the first sub-floor member connections to the second sub-floor.

### DETAILED DESCRIPTION

The following detailed description is of the best currently contemplated modes of carrying out exemplary embodiments of the invention. The description is not to be taken in a limiting sense, but is made merely for the purpose of illustrating the general principles of the invention.

Broadly, embodiments of the present invention provides an athletic court tile, and a system, apparatus and method for applying markings to an athletic court. The athletic court tile of the present invention has an improved play surface and facilitates installation of the court in a selected venue. The automated athletic court paint and assembly line according to other aspects of the present invention eliminates all of the above issues in current court marking techniques and decreases the lead time to ˜2 days by sanding, cleaning, painting, and finishing the panels of wood with automatic equipment before shipment to the final customer.

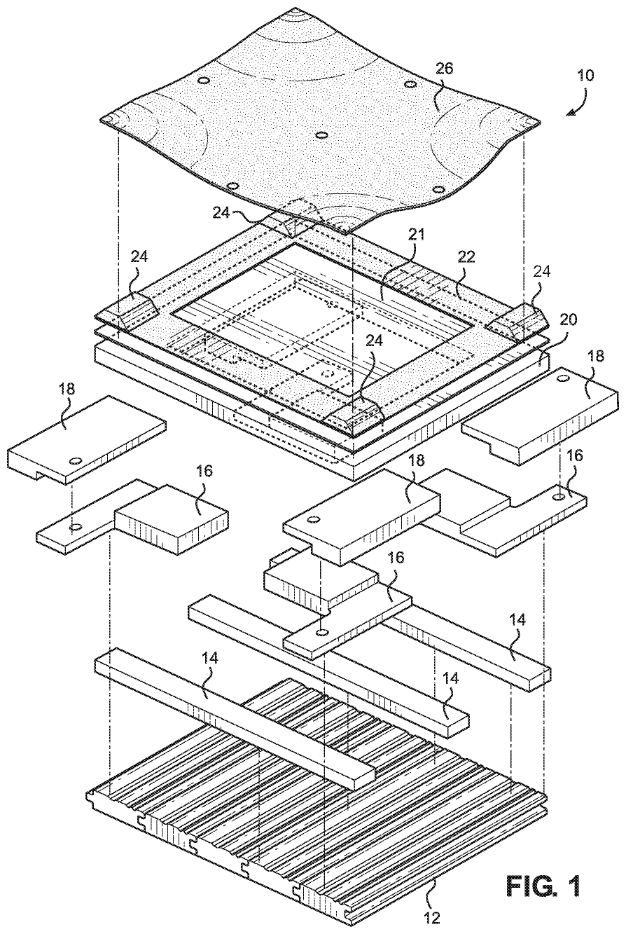

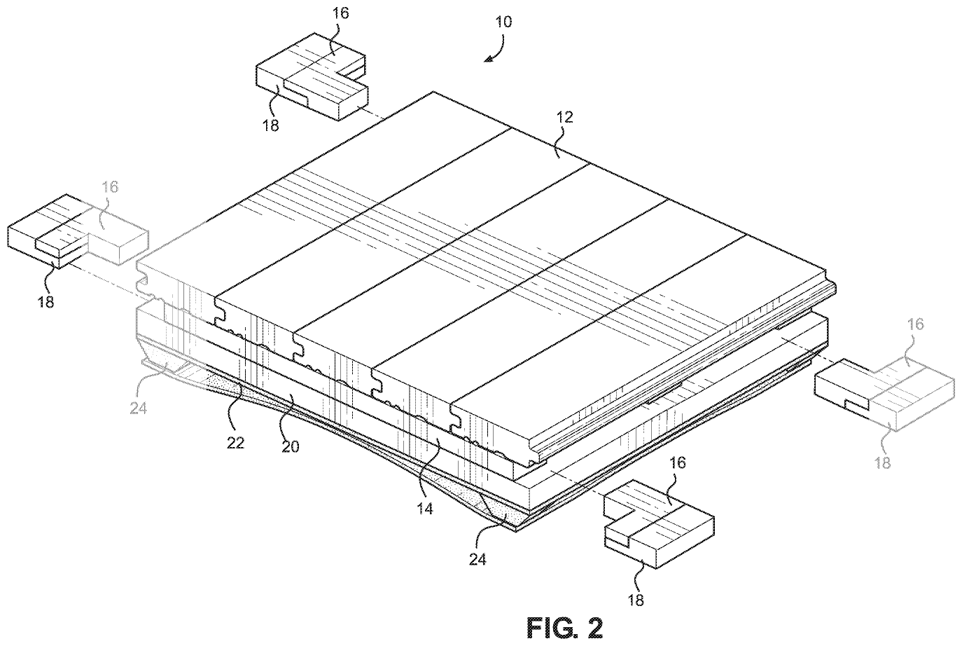

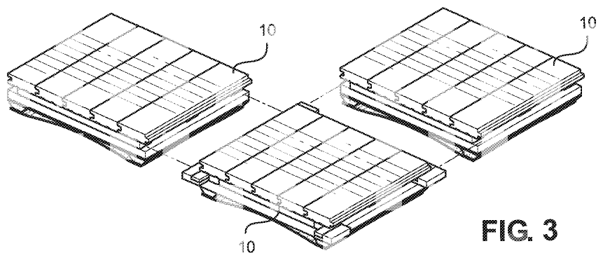

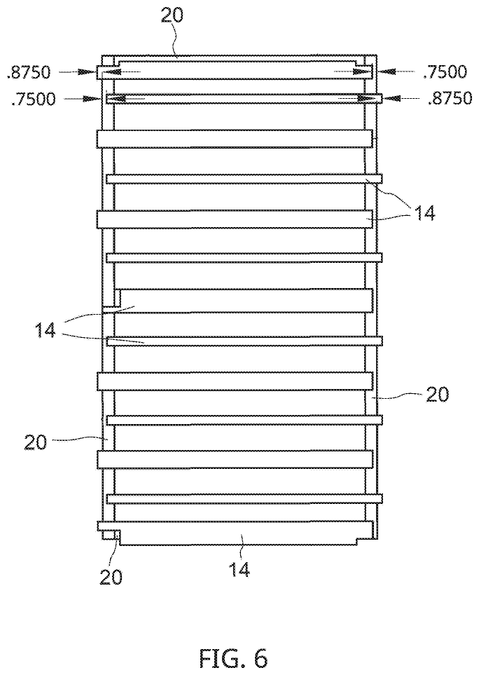

An improved athletic court tile according to aspects of the invention is shown in reference to the drawings of FIGS. 1-3 and 6. The improved athletic court tile 10 is formed of a plurality floor surface boards 12 interconnected in a close-fitting relation. The plurality of floor surface boards 12 are typically made of a wood material, more preferably a hardwood. The plurality of floor surface boards 12 are preferably formed with a tongue and groove joint defined along a longitudinal length of the plurality of floor surface boards 12. The plurality of floor surface boards 12 are dimensioned, when joined, as a rectangular tile.

A first sub floor is formed of a plurality of first sub floor members 14 disposed in a spaced apart relation along the longitudinal length of the plurality of floor surface boards 12. The first sub floor members 14 are laid across a transverse width of the plurality of floor surface boards 12. The first sub floor members 14 are disposed to support the floor surface boards 12 proximal to a first end and a second end of the floor surface boards 12. At least one of the first sub floor members 14 is positioned intermediate the first end and the second end of the floor surface boards 12. A terminal end of each of the first sub floor members 14 is offset from a transverse lateral edge of the rectangular tile. The first sub floor members 14 permit a flexure of the floor surface boards 12 when a force is applied to the floor surface between the first sub floor members 14. The first sub floor members may also be formed of a wood material and may even be formed of a stranded particle board or a plywood material. The first sub floor members 14 may be joined to the floor surface boards 12 by a suitable fastener, such as a screw, nail, or an adhesive.

A second sub floor layer 20 is formed as a rectangular frame having a longitudinal and a transverse dimension corresponding to the rectangular tile of the joined plurality of floor surface boards 12. The second sub floor layer is joined to the first subfloor members 14 by a suitable fastener, such as a screw, nail, or an adhesive. In the transverse dimension, the second sub floor is dimensioned to extend between a face of the groove in the floor surface board 12 and terminate at the base of the tongue element protruding from the opposite side of the floor tile 10, so that the tongue and groove of adjacent floor tiles 10 may be joined with the second sub floor layer 20 of the first floor tile 10 is positioned in abutment with the second sub floor layer 20 of the adjacent floor tile 10. A side edge of a first sub floor member 14 may protrude from a first side edge of the second sub floor layer 20 and the floor surface boards 12. A side edge of a first sub floor member 14 may also be inset from a second side edge of the second sub floor layer 20, to define a tongue and a groove element for the court tile 10. The second subfloor 20 may be formed of a wood material and may include plywood or stranded particle board.

The court tiles 10 are interconnected with the aforementioned tongue and groove provided in the gap between the floor surface boards 12 and the second subfloor 20. The court tiles 10 may also be interconnected via a joint element 16, 18. The joint element is formed as a substantially L-shaped structure that are disposed at the corners of the court tiles 10 and are received in a gap between the floor surface board 12 and the second sub floor layer 20, the gap having a thickness corresponding to a thickness of the plurality of first sub floor members 14. The joint element 16, 18 will have a thickness to fit snugly in the gap. The L-shaped structure has a length corresponding to a distance between the terminal ends of the first sub floor members 14 of an adjacent court tile 10. The first joint element 16 may be utilized alone, such as along a wall surrounding or containing the finished court surface. The first joint element 16 and the second joint element 18 would be utilized together at an intersection of four adjacent court tiles 10, such that a tongue, provided by the joint element 16, 18 is received in a groove defined by the gap in the adjacent court tiles 10.

A moisture barrier 21 may be applied to a bottom surface of the second sub floor layer 20. The moisture barrier 21, may for example be a 10-mil polyethylene moisture barrier 21. A plurality of resilient pads 24 may be disposed in a spaced apart relation around a bottom end of the court tile 10. The plurality of resilient pads 24 provide a cushioning effect between the court tile 10 and a supporting ground surface, or substrate layer. A slide pad 26 is disposed over each of the plurality of resilient pads 24. The slide pad 26 may be formed of a sheet of a polymeric material that permits the court tile 10 to be slid on the supporting ground surface to facilitate positioning of the tiles for interlocking engagement with each other. The slide pad 26 may be joined to the second sub floor layer 20 between the plurality of resilient pads 24 to reduce the surface contact area of the slide pad 26.

As will be described in the following, each of the plurality of court tiles 10 may carry a pre-printed markings and protective finishes corresponding to the finished court markings. As such, the court tiles 10 correspond to a plurality of puzzle pieces that, when connected present the desired markings for the athletic court.

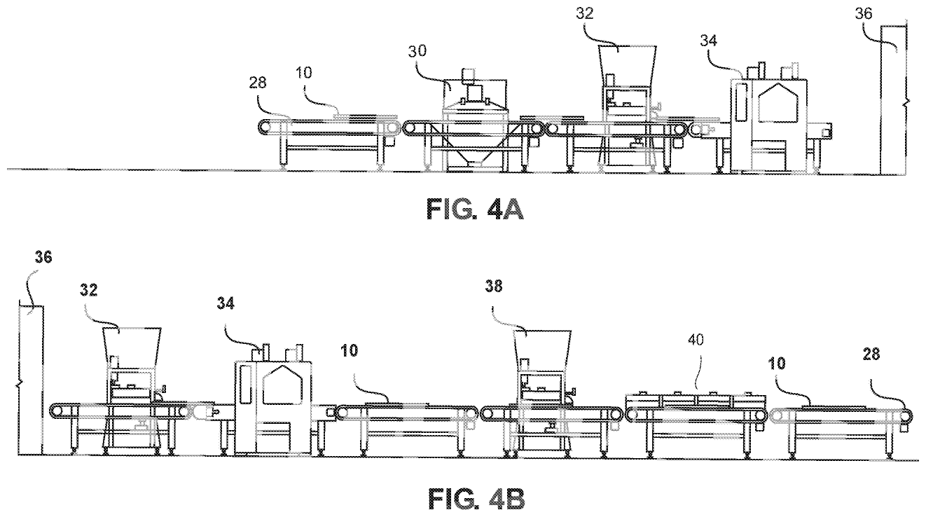

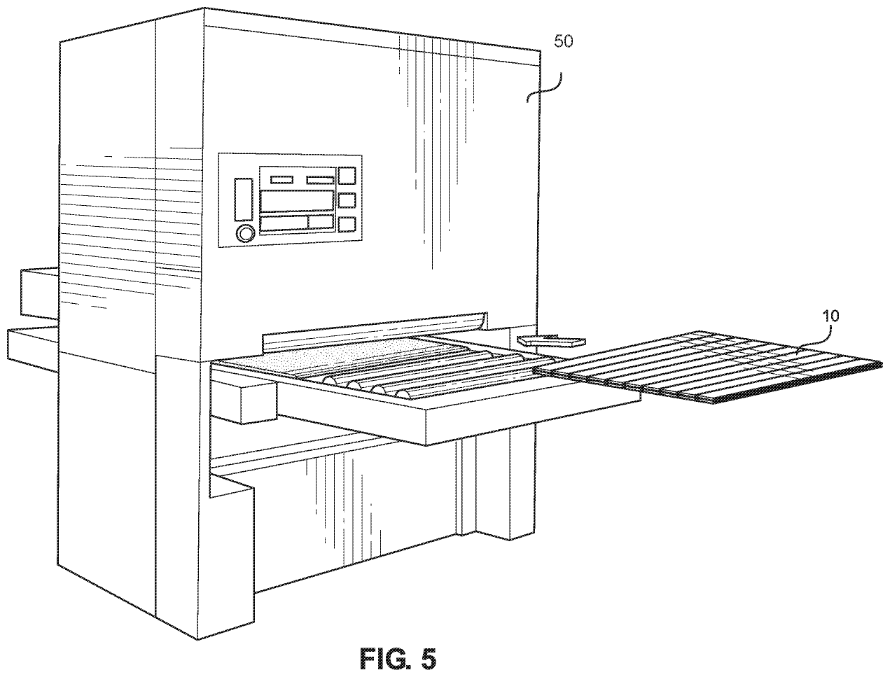

As seen in reference to the drawings of FIGS. 4A-4B and 5, a system and method for pre-applying the court markings to the court tiles 10 is disclosed. The system carries the court tile 10 in a continuous process to limit handling of the court tiles 10 in the process. The one pass court tile 10 marking system according to aspects of the present invention eliminates the need for extensive work applying surface markings to the court to be performed on-site at the installation venue. This allows the marking work to be done in a time-efficient manner, using machines rather than laborers and isolating the potential harmful chemicals to a factory environment wherein they can be properly contained and disposed. This process could be accomplished, for example, through use of UV-curable inks and in-line curing.

Each single process step of the system is designed to add new value to the product according to customers' expectations and specifications for fit, form, and function. The product is transformed from an unmarked court tile 10 into a completed, sanded, painted, and finish-coated floor court tile 10 that will be assembled into a fully functional athletic court with customer selected markings, such as a basketball court, at the customer's site.

The series of steps within system and method work together to flow product continuously through the individual machines and conveyance with minimal labor input, so that finished, wood-floor court tiles 10 result.

In a first stage, a court tile 10 is loaded on an intake conveyor 28, the court tile 10 is then carried to a cleaning station 30 where dust and other contaminants are removed from the court tile 10. The cleaning station 30 may receive the court tile 10 directly from a sander 50, which performs a final smoothing to the joined the floor surface boards 12. From the cleaning station 30, the court tile 10 is carried to a preheating oven 32 to ensure that the exposed face of the floor surface board 12 is at a desired temperature to receive a surface coating. The preheating oven 32, may be IR 1400 Pre-Heat Dryer, manufactured by KeraJet of Castellon, Spain. Preferably the preheating oven 32 is set to obtain temperature of the floor surface board 12 to approximately 115 degrees F.

From the preheating oven 32, the court tile 10 is carried to a first spray booth 34 to apply a seal coat to the sanded wood of the floor surface board 12. The seal coat protects the floor surface board 12 and provides for a more uniform and suitable adhesion layer for the markings to be applied to the court tile 10 in a subsequent step. In a preferred embodiment, the seal coat is a water-borne polyurethane sealant material. The first spray booth 34 may be a BZ1400 Spray Booth manufactured by KeraJet, of Castellon, Spain.

From the first spray booth 34, the court tile 10 is carried to a single pass printer with ultraviolet curing 36, such as a KeraJet S7-1800, manufactured by KERAJet of Castellon, Spain. Each court tile 10 is printed with a desired image segment for the court markings corresponding to the court tile 10 placement on the assembled court. In this regard, each court tile 10 may be individually numbered to correspond to a specified position on the assembled court. The court tiles 10 may then be organized in sequence for installation in the venue. This numbering scheme would be best suited to markings for forming a team logo, where each court tile 10 is marked with a portion of the team logo. Alternatively, each court tile 10 may be numbered according to a common marking type, corresponding to a common location or placement on the assembled court where it may be assembled. By way of non-limiting example, a boundary area may have a single selected color or pattern. Court tile 10 that is imprinted with a boundary marking may be provided a corresponding court tile 10 identification number. Likewise, a court tile 10 without a marking may have a common marking type (null) for placement on the assembled court where no markings are present. Preferably, the ink markings will undergo an ultraviolet curing to harden the markings and prevent blurring in subsequent steps.

From the single pass printer and UV cure 32, the marked court tile 10 is carried to a second preheat oven 32′. The second preheat oven 32′ 32 is set to obtain temperature of the floor surface board 12 to approximately 150 degrees F., to prepare the marked court tile 10 for a subsequent finishing coat.

When the marked court tile 10 has been heated to the desired temperature, the marked court tile 10 is carried to a finishing coat booth 34. The finishing coat may include a water-borne polyurethane finish material. The finishing coat is applied as a protective layer for the marking layer and to provide a durable finish to withstand the rigors of the athletic event and desired traction for the footwear worn on the playing surface.

In a subsequent step, a curing oven 38 may be provided to cure the finishing coat on the surface of the finished court tile 10. The finished court tile 10 may then be conveyed to a cooling zone so that the finished court tile 10 may be handled and carried to a staging area for delivery to the intended venue.

The equipment must be programmed to the specifications of the customer. Each panel is loaded by an operator into the invention where it is sanded, painted, and finished and cured. Once cured, the panels will exit the marking system where they can be stacked and prepared for shipment to the installation site. Additionally: The painting components of this invention could be used to paint other wood and any other flat flooring surface product.

It should be understood, of course, that the foregoing relates to exemplary embodiments of the invention and that modifications may be made without departing from the spirit and scope of the invention as set forth in the following claims.

What is claimed is:

1. A court tile for assembly into an athletic court surface, comprising:
a plurality of floor surface boards interconnected in a close-fitting relation and dimensioned, when joined, as a rectangular tile,
a first sub floor formed of a plurality of sub floor members disposed in a spaced apart relation along a longitudinal length of the floor surface boards. and attached in parallel across a transverse width of the plurality of floor surface boards;
a second sub floor layer attached to the first sub floor, the second sub floor layer formed as a rectangular board having a longitudinal and a transverse dimension corresponding to the rectangular tile of the plurality of floor surface boards;
a plurality of resilient pads disposed in a spaced apart relation around a bottom peripheral edge of the second sub floor layer; and
a slide pad covering the plurality of resilient pads, the slide pad formed of a polymeric material that permits the court tile to be slid on a supporting ground surface.

2. The court tile of claim 1, wherein the plurality of floor surface boards are interconnected in a tongue and a groove fitting.

3. The court tile of claim 1, further comprising:
a moisture barrier disposed subjacent to the second sub floor layer.

4. The court tile of claim 1, wherein a terminal end of each of the plurality of sub floor members is offset from a longitudinal edge of the rectangular tile, defining a gap between a bottom of the plurality of floor surface boards and the second sub floor layer, exposing a channel for air flow.

5. The court tile of claim 4, wherein the plurality of first sub floor members protrude from a first transverse edge of the court tile, defining a tongue element for the court tile; and
the plurality of first sub floor members are inset from an opposite transverse edge of the court tile, defining a groove element for the court tile.

6. The court tile of claim 5; further comprising:
an L-shaped joint element having a thickness dimensioned to fit the gap;
a first leg dimensioned to extend to the terminal end of the first sub floor member and protrude from an outer edge of the rectangular tile;
a second leg dimensioned to protrude from a transverse edge of the rectangular tile; and
the L-shaped joint element adapted to be fit to a corner of the court tile and join a corner or side of an adjacent court tile placed in abutment with the court tile.

7. A system for pre-marking a court tile with a court marking of an athletic court surface formed by a plurality of the court tiles, comprising:
a first spray booth configured to apply a seal coat to a floor surface board of a court tile;
a printer configured to apply a selected portion of an image corresponding to a layout of the athletic court surface;
a second spray booth configured to apply a finishing coat to the floor surface board; and
a conveyor configured to carry the court tile through the system.

8. The system of claim 7, wherein the printer is configured to apply an ultraviolet curable marking material and the printer further comprises:
an ultraviolet curing to the selected portion of the image.

9. The system of claim 8, further comprising:
a cleaning station disposed before the first spray booth, the cleaning station configured to remove surface impurities from at least a top surface of the floor surface board.

10. The system of claim 9, further comprising:
a preheater disposed preceding the first spray booth.

11. The system of claim 10, further comprising:
a preheater disposed preceding the second spray booth.

12. The system of claim 11, further comprising:
a curing oven disposed subsequent to the second spray booth, the curing oven configured to cure the finishing coat on the court tile.

13. The system of claim 12, further comprising:
a cooling zone disposed subsequent to the curing oven, configured to cool the court tile.

14. A method of forming an athletic court having a playing surface carrying a plurality of markings for an athletic event played on the athletic court, comprising:
joining a plurality of interconnected floor surface boards to form a court tile, the court tile interconnectable with a plurality of court tiles to define a playing surface of the athletic court.

15. The method of claim 14, further comprising:
marking each of the plurality of court tiles with a selected segment of the plurality of markings before the plurality of court tiles are assembled as the athletic court.

16. The method of claim 15, further comprising:
positioning each of the plurality of court tiles according to an intended placement in the athletic court.

17. The method of claim 16, further comprising:
indexing each of the plurality of court tiles according to the intended placement in the athletic court.

18. The method of claim 17, further comprising:
joining each of the plurality of court tiles in a venue according the intended placement, wherein once joined, the plurality of court tiles present the plurality of markings according to a specified disposition for the athletic event a playing surface.
